(19) United States
(12) Patent Application Publication
(10) Pub. No.: US 2015/0348362 A1
(43) Pub. Date: Dec. 3, 2015

(54) OPERATION UNIT

(71) Applicant: OMRON Corporation, Kyoto-shi, Kyoto (JP)

(72) Inventor: Ryoji Okazaki, Aichi (JP)

(73) Assignee: OMRON Corporation, Kyoto-shi, Kyoto (JP)

(21) Appl. No.: 14/435,552

(22) PCT Filed: Sep. 10, 2013
(86) PCT No.: PCT/JP2013/005356

§ 371 Date: Apr. 14, 2015

(30) Foreign Application Priority Data
Nov. 22, 2012 (JP) 2012-256804

(51) Int. Cl. G07F 17/32; F21V 3/04; F21V 33/00

(52) U.S. Cl. CPC G07F 17/3213; F21V 33/008; F21V 3/049

(57) ABSTRACT

An operation unit includes a first push-button switch; a diffusion unit that diffuses light incident from a light-emitting part, and radiates light from a periphery of the first push-button switch; and a rotary mechanism that rotates the diffusion unit. The diffusion unit may have a through-hole, the rotary mechanism may rotate the diffusion unit about a rotation axis that passes through the through-hole, and the first push-button switch may be provided on the rotation axis.

### CROSS-REFERENCE TO RELATED APPLICATIONS

This application claims the benefit of International Application PCT/JP2013/005356, filed on Sep. 10, 2013 and Japanese Patent Application No. 2012-256804 filed on Nov. 22, 2012, both of which are incorporated herein by reference in their entirety.

### BACKGROUND

1. Technical Field

Embodiments of the present invention generally relate to an operation unit.

2. Related Art

There are a number of models of game machines such as slot machines Decoration of game machines is an important aspect for one specific model to be selected from among a number of models by a player. Patent Literature 1 discloses an operation button unit comprising an LED that illuminates a button from inside (for example, please see Patent Literature 1).

Patent Literature 1: Japanese Patent Application Publication No. 2009-61049

One or more embodiments described below may improve the decorativeness of an operation unit provided to a game machine and the like.

### SUMMARY

An operation unit according to one or more embodiments of the present invention comprises: a first push-button switch; a diffusion unit that diffuses light incident from a light-emitting part, and radiates light from a periphery of the first push-button switch; and a rotary mechanism that rotates the diffusion unit.

In the operation unit, the diffusion unit may have a through-hole, the rotary mechanism may rotate the diffusion unit about a rotation axis that passes through the through-hole, and the first push-button switch may be provided on the rotation axis.

The operation unit may further comprise, below the first push-button switch, a display unit that displays an image including a first object, wherein the first push-button switch may be provided above a display area of the first object, and make visible the first object through a pressing surface of the first push-button switch.

The operation unit may further comprise a second push-button switch, wherein the display unit may display the image further including a second object, and the second push-button switch may be provided above a display area of the second object, and make visible the second object through a pressing surface of the second push-button switch.

The operation unit may further comprise a third push-button switch and a fourth push-button switch, wherein the display unit may display the image further including a third object and a fourth object, the third push-button switch may be provided above a display area of the third object, and make visible the third object through a pressing surface of the third push-button switch, and the fourth push-button switch may be provided above a display area of the fourth object, and make visible the fourth object through a pressing surface of the fourth push-button switch.

In the operation unit, the first push-button switch and the second push-button switch may be provided side by side in a first direction that is parallel with a screen of the display unit, and the second push-button switch, the third push-button switch, and the fourth push-button switch may be provided side by side in a second direction that is parallel with the screen of the display unit and is vertical to the first direction.

In the operation unit, the second push-button switch may be provided between the third push-button switch and the fourth push-button switch.

In the operation unit, the pressing surface of the first push-button switch may be round, the pressing surface of the second push-button switch may be rectangular, and the pressing surfaces of the third push-button switch and the fourth push-button switch may be triangular.

The operation unit may further comprise an elastic sheet between the first push-button switch, the second push-button switch, the third push-button switch, and the fourth push-button switch, and the display unit, wherein the first push-button switch, the second push-button switch, the third push-button switch, and the fourth push-button switch may have leg parts that are supported on the elastic sheet.

In the operation unit, the elastic sheet may have a through-hole below the first push-button switch, and the operation unit may further comprise, inside the through-hole of the elastic sheet, an elastic body that supports the first push-button switch.

The operation unit may further comprise a base plate that is provided between the elastic sheet and the display unit, and has, on a surface on the elastic sheet side, a plurality of fixed contacts facing the leg part of each of the first push-button switch, the second push-button switch, the third push-button switch, and the fourth push-button switch, wherein the elastic sheet may have, on a surface on the base plate side, a plurality of movable contacts facing the plurality of fixed contacts.

In the operation unit, the base plate may have a plurality of through-holes that face the pressing surface of each of the first push-button switch, the second push-button switch, the third push-button switch, and the fourth push-button switch.

The operation unit may further comprise the light-emitting part that is provided on the base plate, and allows light to be incident on the diffusion unit.

In the operation unit, the light-emitting part may have a plurality of light-emitting elements, and the plurality of light-emitting elements may be provided with intervals therebetween on the base plate, along the outer circumference of a through-hole that faces the pressing surface of the first push-button switch, from among the plurality of through-holes of the base plate.

The operation unit may further comprise a plurality of other light-emitting elements that radiate light from peripheries of the second push-button switch, the third push-button switch, and the fourth push-button switch, wherein the plurality of other light-emitting elements may be provided with intervals therebetween on the base plate along the outer circumference of each through-hole that faces the pressing surfaces of the second push-button switch, the third push-button switch, and the fourth push-button switch, from among the plurality of through-holes of the base plate.

In the operation unit, the diffusion unit may have a disk body including, on its outer circumference, a plurality of teeth, and the rotary mechanism may have: a toothed wheel including, on its outer circumference, a plurality of teeth that gear the plurality of teeth of the disk body; and have a drive part that rotates the toothed wheel.

The summary clause does not necessarily describe all necessary features of one or more embodiments of the present invention. One or more embodiments of the present invention may also be a sub-combination of the features described above.

### BRIEF DESCRIPTION OF THE DRAWINGS

FIG. 1 is one example of an external perspective view of a slot machine according to one or more embodiments.

FIG. 2 is an external perspective view of an operation unit according to one or more embodiments.

FIG. 3 is an exploded perspective view of an operation unit according to one or more embodiments.

FIG. 4 is a perspective view of an operation unit according to one or more embodiments, illustrating a cross section of a part thereof.

FIG. 5 is an external perspective view of a push-button switch according to one or more embodiments.

FIG. 6 is an external perspective view of a rubber sheet according to one or more embodiments.

FIG. 7 is an external perspective view of a base plate according to one or more embodiments.

FIG. 8 is an external perspective view of a spectral wall according to one or more embodiments.

FIG. 9 is an external perspective view of a diffusion rotary body according to one or more embodiments.

FIG. 10 is an external perspective view of a gear according to one or more embodiments.

FIG. 11 is a front view of an operation surface of an operation unit according to one or more embodiments.

FIG. 12 is a sectional view taken along the line A-A illustrated in one or more embodiments of FIG. 11.

FIG. 13 is a sectional view taken along the line B-B illustrated in one or more embodiments of FIG. 11.

FIG. 14 is a sectional view taken along the line C-C illustrated in one or more embodiments of FIG. 11.

FIG. 15 is a figure that illustrates one example of objects that are made visible through a pressing surface of a push-button switch according to one or more embodiments.

FIG. 16 is a figure that illustrates one example of an image that is displayed on a display part of a slot machine according to one or more embodiments.

FIG. 17 is a figure that illustrates another example of objects that are made visible through a pressing surface of a push-button switch according to one or more embodiments.

FIG. 18 is a figure that illustrates another example of an image that is displayed on a display part of a slot machine according to one or more embodiments.

### DETAILED DESCRIPTION

Hereinafter, one or more embodiments of the present invention will be described. The embodiment(s) do(es) not limit the invention according to the claims, and all the combinations of the features described in the embodiment(s) are not necessarily essential to means provided by aspects of the invention.

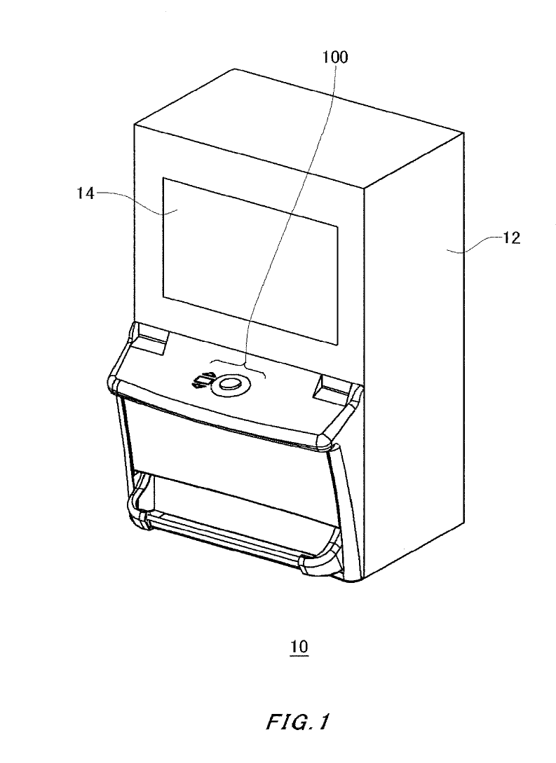

FIG. 1 is one example of an external perspective view of a slot machine 10 according to one or more embodiments. The slot machine 10 comprises a main body 12, a display part 14, and an operation unit 100. The slot machine 10 is one example of game machines. Note that the operation unit 100 may be mounted on other game machines such as Japanese pinballs, Japanese slot machines, and game consoles.

The display part 14 may display game images including a plurality of reels indicating multiple types of patterns, winning lines that define combinations of patterns, and the number of bets that indicate a money amount betted on winning lines. Other than primary games of game machines, the display part 14 may display images about a so-called mini game that is started under predetermined conditions during the games.

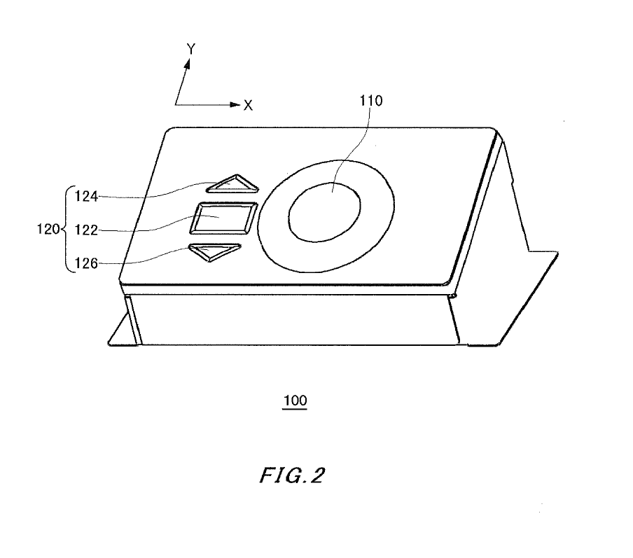

FIG. 2 is one example of an external perspective view of the operation unit 100 according to one or more embodiments. The operation unit 100 comprises a push-button switch 110 and a push-button switch set 120. The push-button switch set 120 is placed adjacent to the push-button switch 110 in the X-axis direction. The push-button switch set 120 includes a push-button switch 122, a push-button switch 124, and a push-button switch 126. The push-button switch 122, the push-button switch 124, and the push-button switch 126 are placed in one line along the Y-axis direction. The push-button switch 122 is placed between the push-button switch 124 and the push-button switch 126.

The push-button switch 110 is one example of a first push-button switch, and for example is a push-button switch that has a round pressing surface, and outputs an instruction about rotation of a reel. The push-button switch 122 is one example of a second push-button switch, and is for example a push-button switch that has a rectangular pressing surface, and outputs an instruction corresponding to one selection target item that is presented from among a plurality of items. The push-button switch 124 is one example of a third push-button switch, and is a push-button switch that has a triangular pressing surface, and outputs an instruction to switch, in an ascending order, selection target items from among a plurality of items which are associated in advance with a presentation order. The push-button switch 126 is one example of a fourth push-button switch, and is a push-button switch that has a triangular pressing surface, and outputs an instruction to switch, in a descending order, selection target items from among a plurality of items which are associated in advance with a presentation order.

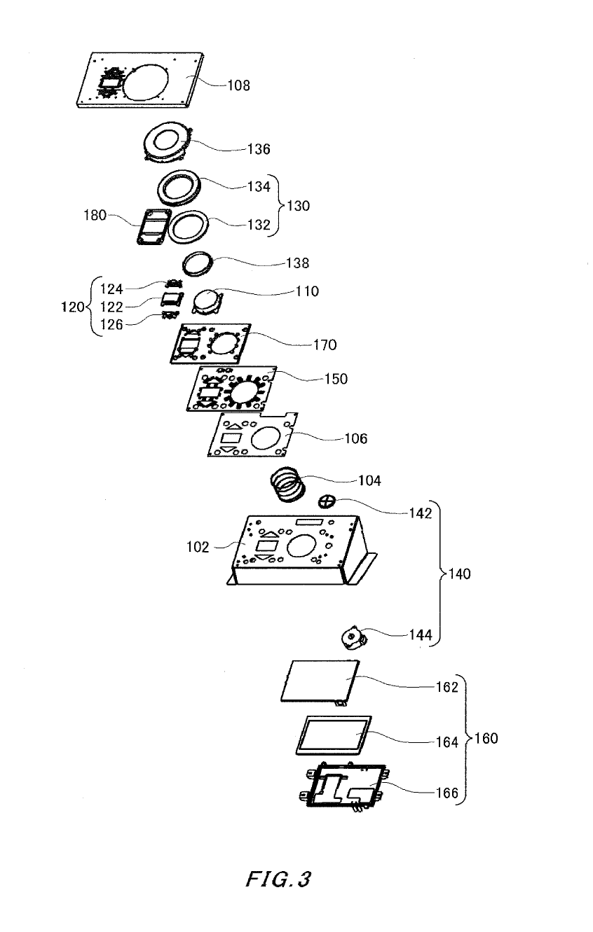

FIG. 3 illustrates an exploded perspective view of the operation unit 100 according to one or more embodiments. The operation unit 100 comprises a display unit 160, a rotary mechanism 140, a bracket 102, a spring 104, an insulation sheet 106, a base plate 150, a rubber sheet 170, the push-button switch 110, the push-button switch set 120, a bush 138, a diffusion unit 130, a spectral wall 180, a diffusion unit cover 136, and an operation unit cover 108.

The display unit 160 has a liquid crystal display (LCD) 164, an LCD cover 162, and an LCD case 166. The LCD 164 is housed in the LCD case 166, and is covered with the transparent LCD cover 162.

The rotary mechanism 140 has a motor 144 and a gear 142. The gear 142 is rotated by the motor 144. The diffusion unit 130 has a diffuser panel 132 and a diffusion rotary body 134. The diffusion unit 130 is rotated by the rotary mechanism 140.

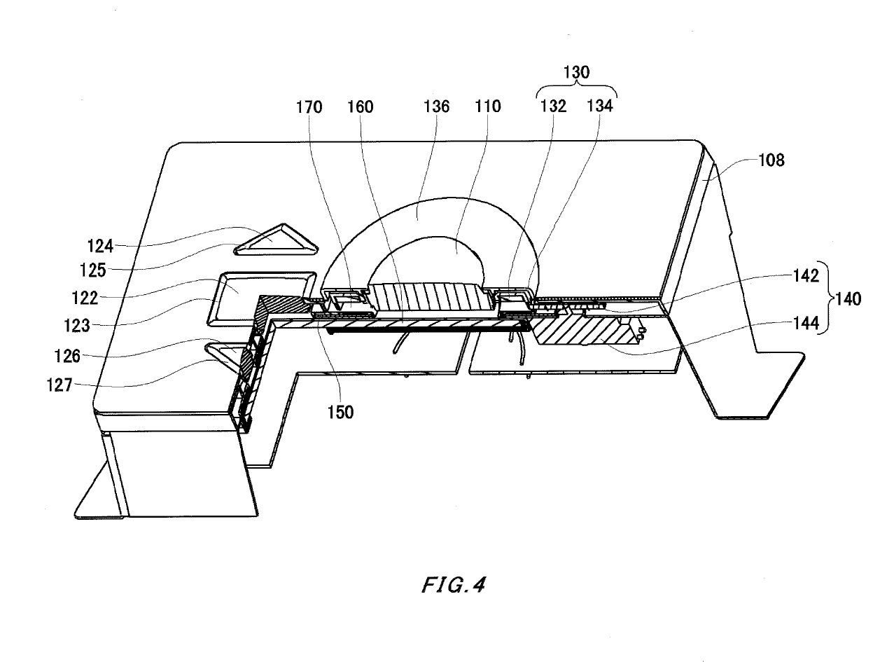

FIG. 4 is a perspective view of the operation unit 100 according to one or more embodiments, illustrating a cross section of a part thereof. The operation unit 100 comprises therein the display unit 160.

The display unit 160 is placed below the push-button switch 110, the push-button switch 122, the push-button switch 124, and the push-button switch 126. The push-button switch 110, the push-button switch 122, the push-button switch 124, and the push-button switch 126 make visible, through their pressing surfaces, parts of an image displayed on the display unit 160. The display unit 160 displays an operation image including, in areas that correspond to respective positions of the push-button switch 110, the push-button switch 122, the push-button switch 124, and the push-button switch 126, respective objects such as text and graphics that correspond to respective functions of the push-button switch 110, the push-button switch 122, the push-button switch 124, and the push-button switch 126.

The push-button switch 110, the push-button switch 122, the push-button switch 124, and the push-button switch 126 are each provided above display areas of objects that correspond to their respective functions from among display areas of the display unit 160, and make visible, through their pressing surfaces, the objects that correspond to their respective functions.

The push-button switch 110, the push-button switch 122, the push-button switch 124, and the push-button switch 126 have been subjected to solid immersion lens processing, respectively, magnify a partial image of an image being displayed on the display unit 160, and make visible the partial image through their pressing surfaces. Thereby, depth feel of an image visible through the pressing surfaces can be removed.

The diffusion unit 130 has a through-hole. The diffuser panel 132 and the diffusion rotary body 134 have through-holes at mutually facing positions. The push-button switch 110 is placed inside the through-hole of the diffusion unit 130. The diffusion unit cover 136 is configured with a half mirror, and covers the diffusion unit 130 from above. The diffuser panel 132 diffuses light that is incident from an LED provided to the base plate 150, and radiates light from a periphery of the push-button switch 110 through the diffusion rotary body 134 and the diffusion unit cover 136. The LED is one example of a light-emitting element. Because the diffusion unit cover 136 is configured with a half mirror, the base plate 150 and the like inside the operation unit 10 are not visible through the diffusion unit cover 136 when the LED is not radiating light. Thereby, the decorativeness can be improved.

The diffusion rotary body 134 is, at its side surface, in contact with the gear 142, and responding to rotation of the gear 142 by the motor 144, rotates about a rotation axis that passes through the through-hole of the diffusion unit 130. Because the diffuser panel 132 is configured integrally with the diffusion rotary body 134, the diffuser panel 132 rotates about the rotation axis responding to rotation of the diffusion rotary body 134. In this manner, because the diffuser panel 132 rotates, the decorative effect can be improved even if the number of light-emitting elements provided to the base plate 150 is small.

Also, illumination parts 123, 125, and 127 configured with a transparent or semi-transparent material are placed around the push-button switch 122, the push-button switch 124, and the push-button switch 126. The base plate 150 has a plurality of LEDs at positions that face the illumination parts 123, 125, and 127. The plurality of LEDs radiates light from peripheries of the push-button switch 122, the push-button switch 124, and the push-button switch 126 through the illumination parts 123, 125, and 127. Thereby, peripheries of the push-button switch 122, the push-button switch 124, and the push-button switch 126 can be decorated with light. Note that the illumination parts 123, 125, and 127 may be configured integrally with the operation unit cover 108.

The operation unit 100 comprises the rubber sheet 170 that is one example of an elastic sheet between the push-button switch 110, the push-button switch 122, the push-button switch 124, and the push-button switch 126, and the base plate 150. The push-button switch 110, the push-button switch 122, the push-button switch 124, and the push-button switch 126 are placed on the rubber sheet 170.

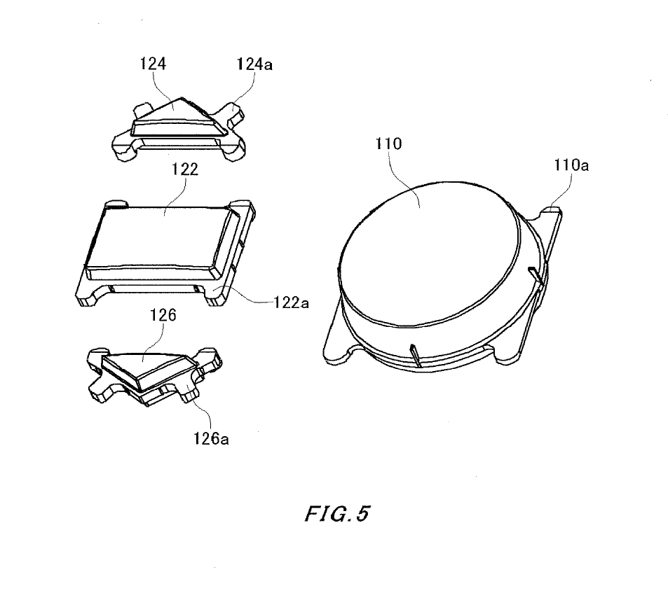

FIG. 5 is an external perspective view of the push-button switch 110 according to one or more embodiments, the push-button switch 122, the push-button switch 124, and the push-button switch 126. The push-button switch 110, the push-button switch 122, the push-button switch 124, and the push-button switch 126 have a plurality of leg parts 110a, 122a, 124a, and 126a supported on the rubber sheet 170.

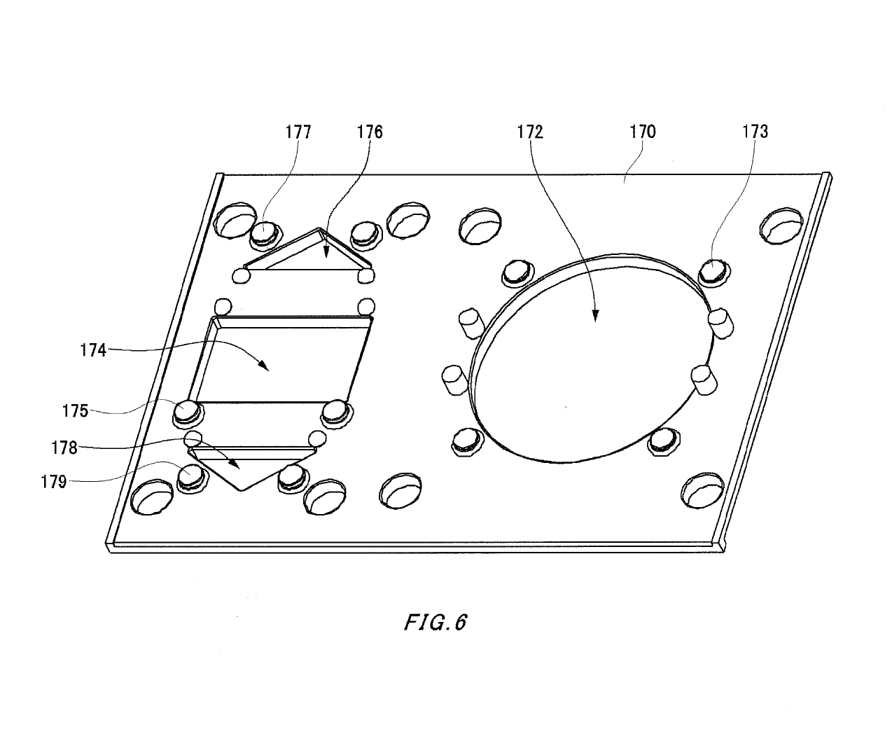

FIG. 6 illustrates an external perspective view of the rubber sheet 170 according to one or more embodiments. The rubber sheet 170 has through-holes 172, 174, 176, and 178 at positions that face the respective pressing surfaces of the push-button switch 110, the push-button switch 122, the push-button switch 124, and the push-button switch 126. The rubber sheet 170 has a plurality of protruding parts 173, 175, 177, and 179 at positions, around the through-holes 172, 174, 176, and 178, that face plurality of leg parts 110a, 122a, 124a, and 126a.

The plurality of protruding parts 173, 175, 177, and 179 function as movable contacts, and when the push-button switch 110, the push-button switch 122, the push-button switch 124, and the push-button switch 126 are pressed, are pressed by the plurality of leg parts 110a, 122a, 124a, and 126a, and pushed to the base plate 150 side. The plurality of protruding parts 173, 175, 177, and 179 are elastic, and when the push-button switch 110, the push-button switch 122, the push-button switch 124, and the push-button switch 126 are no longer pressed, can return to the positions before being pushed.

Conductive layers such as carbon layers or metal layers are formed on surfaces of the plurality of protruding parts 173, 175, 177, and 179 on the base plate 150 side. When the push-button switch 110, the push-button switch 122, the push-button switch 124, and the push-button switch 126 are pressed, the conductive layers of the plurality of protruding parts 173, 175, 177, and 179 cause short circuits in opposite electrodes that configure fixed contacts on the base plate 150.

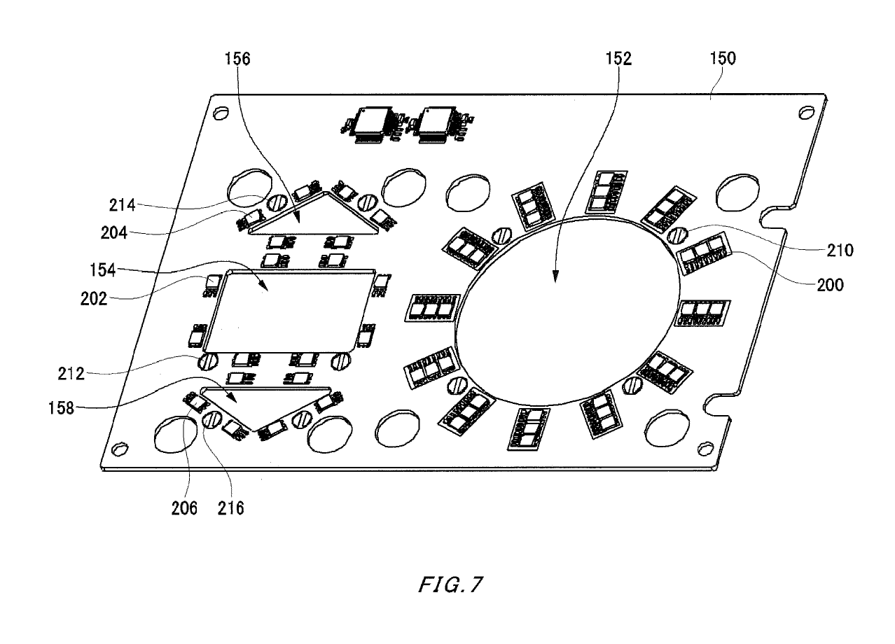

FIG. 7 illustrates an external perspective view of the base plate 150 according to one or more embodiments. The base plate 150 has through-holes 152, 154, 156, and 158 at positions that face the respective pressing surfaces of the push-button switch 110, the push-button switch 122, the push-button switch 124, and the push-button switch 126. The base plate 150 has a plurality of LEDs 200, 202, 204, and 206 that are placed at intervals along the outer circumference of the through-holes 152, 154, 156, and 158. The plurality of LEDs 200 radiates light from a periphery of the push-button switch 110 through the diffusion unit 130. The plurality of LEDs 202 radiates light from a periphery of the push-button switch 122 through the illumination part 123. The plurality of LEDs 204 radiates light from a periphery of the push-button switch 124 through the illumination part 125. The plurality of LEDs 206 radiates light from a periphery of the push-button switch 126 through the illumination part 127.

The base plate 150 has opposite electrodes 210, 212, 214, and 216 that are fixed contacts at positions that are between the plurality of LEDs 200, 202, 204, and 206, and face the plurality of protruding parts 173, 175, 177, and 179 provided to the rubber sheet 170. When the opposite electrodes 210, 212, 214, and 216 cause short circuits by being in contact with the conductive layers of the plurality of protruding parts 173, 175, 177, and 179, pressing of the push-button switch 110, the push-button switch 122, the push-button switch 124, and the push-button switch 126 is sensed.

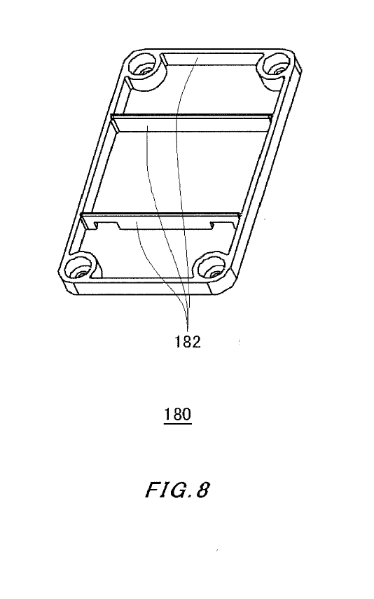

FIG. 8 is an external perspective view of the spectral wall 180. The spectral wall 180 has wall parts 182 that define the push-button switch 122, the push-button switch 124, and the push-button switch 126, and the wall parts 182 prevent light emitted by the LEDs 202, 204, and 206 that correspond respectively to the push-button switch 122, the push-button switch 124, and the push-button switch 126 from being radiated from a periphery of another non-corresponding push-button switch. Because the spectral wall 180 surrounds peripheries of the push-button switch 122, the push-button switch 124, and the push-button switch 126, only a periphery of a push-button switch that corresponds to an LED emitting light can be illuminated. Thereby, the decorativeness can be improved.

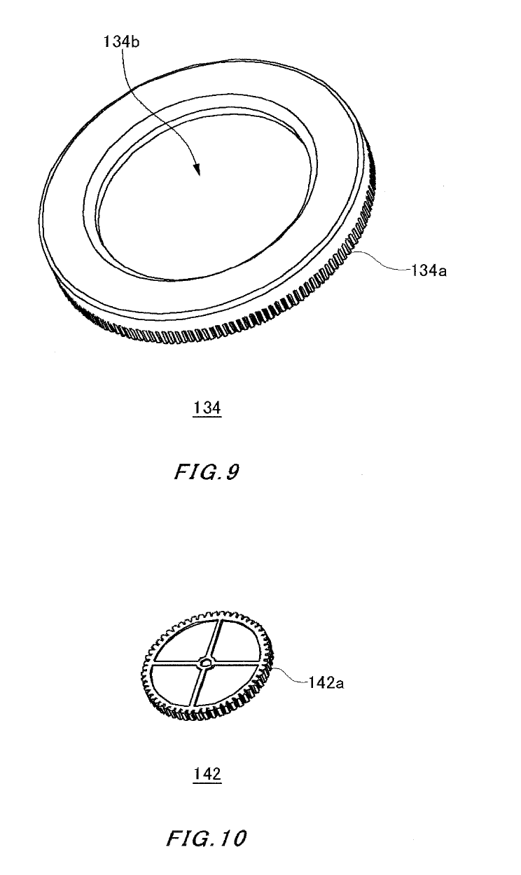

FIG. 9 illustrates an external perspective view of the diffusion rotary body 134 according to one or more embodiments. FIG. 10 illustrates an external perspective view of the gear 142 according to one or more embodiments. The diffusion rotary body 134 is a ring-shaped disk body, and has a plurality of teeth 134a on its outer circumference. The gear 142 has, on its outer circumference, a plurality of teeth 142a that gear the plurality of teeth 134a of the diffusion rotary body 134. Responding to rotation of the gear 142 by the motor 144, the plurality of teeth 134a of the diffusion rotary body 134 gear the plurality of teeth 142a of the gear 142, and the diffusion rotary body 134 rotates about a rotation axis that passes through the midpoint of a through-hole 134b.

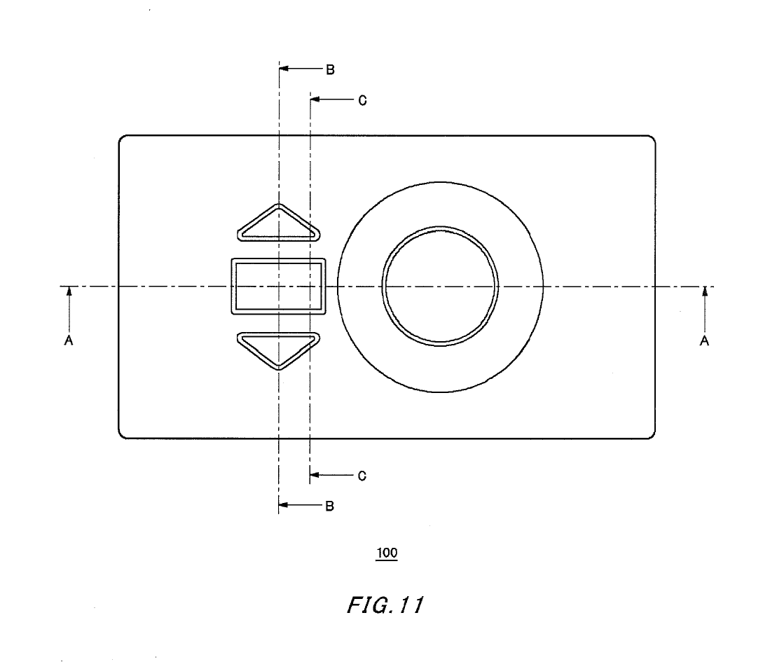

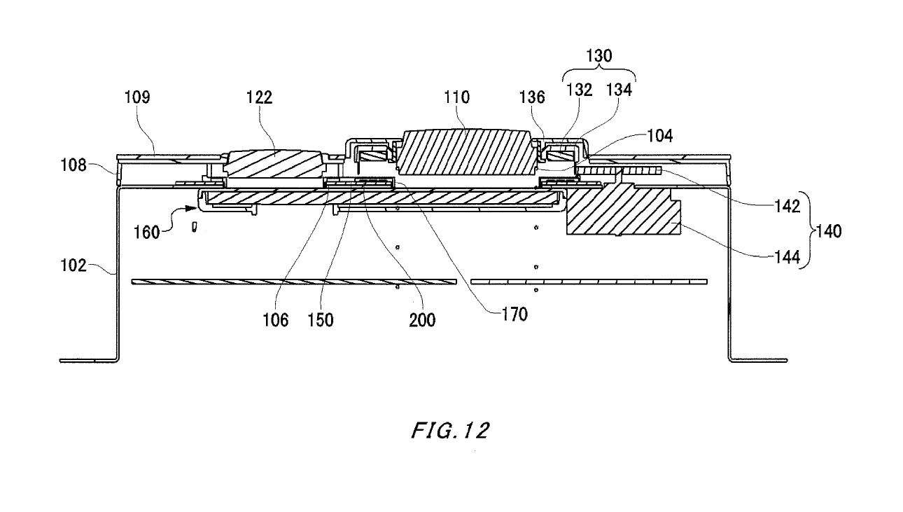

FIG. 11 illustrates a front view of an operation surface of the operation unit 100 according to one or more embodiments. FIG. 12 illustrates a sectional view taken along the line A-A illustrated in FIG. 11.

The display unit 160 is placed on the rear surface of the bracket 102. The bracket 102 has through-holes at positions that face the pressing surfaces of the push-button switch 110, the push-button switch 122, the push-button switch 124, and the push-button switch 126. The motor 144 is further placed on the rear surface of the bracket 102. The bracket 102 has another through-hole at a position that corresponds to a drive shaft of the motor 144.

The insulation sheet 106 is placed at a position, of the front surface of the bracket 102, that faces the display unit 160. The base plate 150 is placed on the insulation sheet 106. The rubber sheet 170 is placed on the base plate 150. The insulation sheet 106, the base plate 150, and the rubber sheet 170 have through-holes at positions that face the pressing surfaces of the push-button switch 110, the push-button switch 122, the push-button switch 124, and the push-button switch 126. The push-button switch 110, the push-button switch 122, the push-button switch 124, and the push-button switch 126 make visible, through their pressing surfaces, objects that correspond to their respective functions included in images being displayed on the display unit 160.

The push-button switch 110, the push-button switch 122, the push-button switch 124, and the push-button switch 126 are supported on the rubber sheet 170 via their respective leg parts. Also, the operation unit 100 further has the spring 104 inside a through-hole formed at positions, of the bracket 102, the insulation sheet 106, the base plate 150, and the rubber sheet 170, that face the pressing surface of the push-button switch 110. The push-button switch 110 is supported also by the spring 104. The push-button switch 110 is larger in size than the push-button switch 122, the push-button switch 124, and the push-button switch 126. Also, because the push-button switch 110 functions as a push-button switch for instructing rotation of a reel, the push-button switch 110 is more frequently used than the push-button switch 122, the push-button switch 124, and the push-button switch 126. For this reason, it is possible that the push-button switch 110 does not, only with the elastic force of the rubber sheet 170, return to its original position after being pressed. To cope with this, by providing the spring 104, the elastic force of the spring 104 is added to the elastic force of the rubber sheet 170. Thereby, the push-button switch 110 can surely be returned to its original position after being pressed.

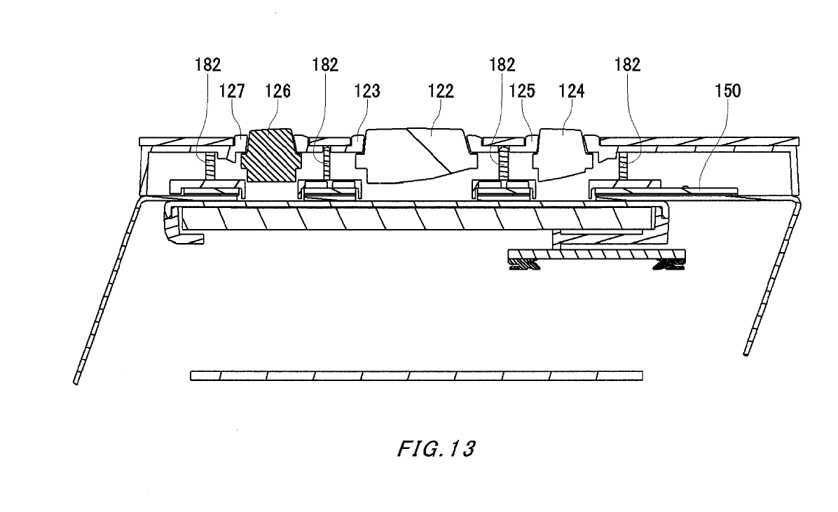

FIG. 13 illustrates a sectional view taken along the line B-B illustrated in one or more embodiments of FIG. 11. The push-button switch 122, the push-button switch 124, and the push-button switch 126 are placed in respectively separate spaces that are defined respectively by the wall parts 182 of the spectral wall 180. Accordingly, when an LED that corresponds to one push-button switch emits emit, light from the LED can be prevented from being incident onto a space of another push-button switch. Also, light reflected by the wall parts 182 is radiated externally via the illumination parts 123, 125, and 127 placed at upper parts of respective spaces. Thereby, a periphery of a corresponding push-button switch is illuminated with light.

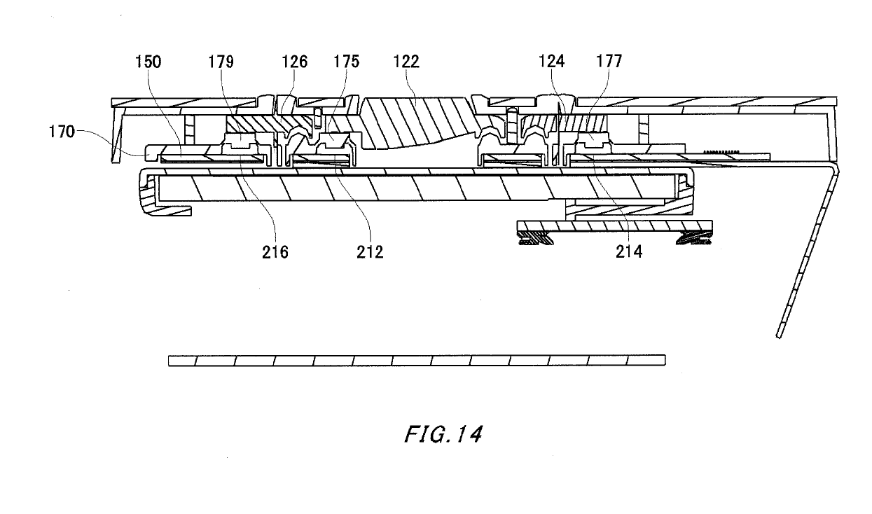

FIG. 14 illustrates a sectional view taken along the line C-C illustrated in one or more embodiments of FIG. 11. The push-button switch 122, the push-button switch 124, and the push-button switch 126 are supported, at their leg parts, on the protruding parts 175, 177, and 179 that are movable contacts on the rubber sheet 170. The base plate 150 has, at positions that face the protruding part 175, 177, and 179, the opposite electrodes 212, 214, and 216 that are fixed contacts. When the push-button switch 122, the push-button switch 124, and the push-button switch 126 are pressed, the protruding part 175, 177, and 179 are pushed to the base plate 150 side, and the protruding part 175, 177 and 179 come into contact with the opposite electrodes 212, 214, and 216. Thereby, the opposite electrodes 212, 214, and 216 are short-circuited, and pressing of the push-button switch 122, the push-button switch 124, and the push-button switch 126 can be sensed.

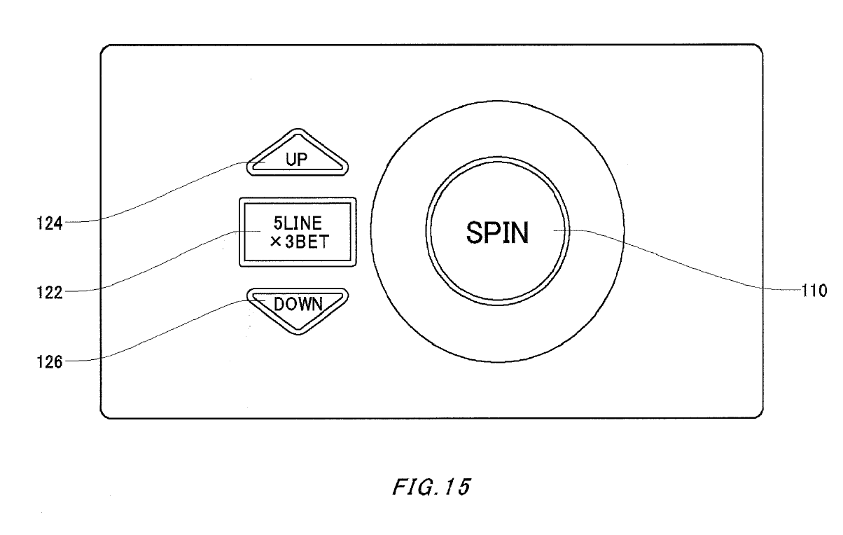

FIG. 15 illustrates one example of objects that are made visible through the pressing surfaces of the push-button switch 110 according to one or more embodiments, the push-button switch 122, the push-button switch 124, and the push-button switch 126.

The display unit 160 displays, at a position that corresponds to the pressing surface of the push-button switch 110, an operation image including an object including text “SPIN” indicating an instruction to rotate a reel. An operation image displayed by the display unit 160 includes, at a position that corresponds to the pressing surface of the push-button switch 122, a selection target item object that should present, as a selection target item, any one of a plurality of items that indicate combinations of the numbers of bets that indicate betted money amounts, and the numbers of lines of winning lines. Note that an object displayed by the display unit 160 that indicates a combination of the number of lines and the number of bets is memorized in a memory in advance for each combination of the number of lines and the number of bets. A plurality of items that indicate combinations of the numbers of bets that indicate betted money amounts and the numbers of lines of winning lines are respectively associated in advance with a presentation order.

When the push-button switch 122 is pressed, a combination of the number of bets and the number of lines that is being displayed, as the selection target item object, at a position that corresponds to the pressing surface of the push-button switch 122 is set as a game condition, and a game is performed.

The operation image displayed by the display unit 160 further includes, at a position that corresponds to the pressing surface of the push-button switch 124, an ascending order object including text “UP” that indicates switching of selection target item objects in an ascending order. In addition, the operation image displayed on the display unit 160 further includes, at a position that corresponds to the pressing surface of the push-button switch 126, a descending order object including text “DOWN” that indicates switching of selection target item objects in a descending order.

As described above, by assigning a combination of the number of lines and the number of bets to one push-button switch, the number of push-button switches can reduced as compared with a case where a push-button switch for setting the number of lines and a push-button switch for setting the number of bets are provided separately. Also, by switching combinations of the numbers of lines and the numbers of bets assigned to a push-button switch by the push-button switch, the number of push-button switches can be reduced as compared with a case where push-button switches are provided separately for respective combinations of the numbers of lines and the numbers of bets. Thereby, the installation space of push-button switches can be reduced significantly.

When the space for adding an operation button and the like is small, for example, the display part 14 that is a main screen of a slot machine may be configured with a touch panel display, and the display part 14 may be allowed to function as an operation unit having another function. However, some players cannot reach for the display part 14 that is a main screen of a slot machine, or may feel it is bothersome to perform touch operation by using a touch panel display. Because the operation unit 100 according to the present embodiment allows installation within a relatively small space, it is easy to install the operation unit 100 on an operation board that is originally provided to the main body 12 of the slot machine 10. Therefore, it is possible to easily install the operation unit 100 in which a plurality of operation functions are integrated, at a location that allows easy operation even for a player who does not prefer the above-mentioned touch panel display.

Also, because the installation space for push-button switches can be reduced significantly, the space for setting the diffusion unit 130, and the space for installing the rotary mechanism 140 for rotating the diffusion unit 130 can be easily reserved around the push-button switch 110 as described above.

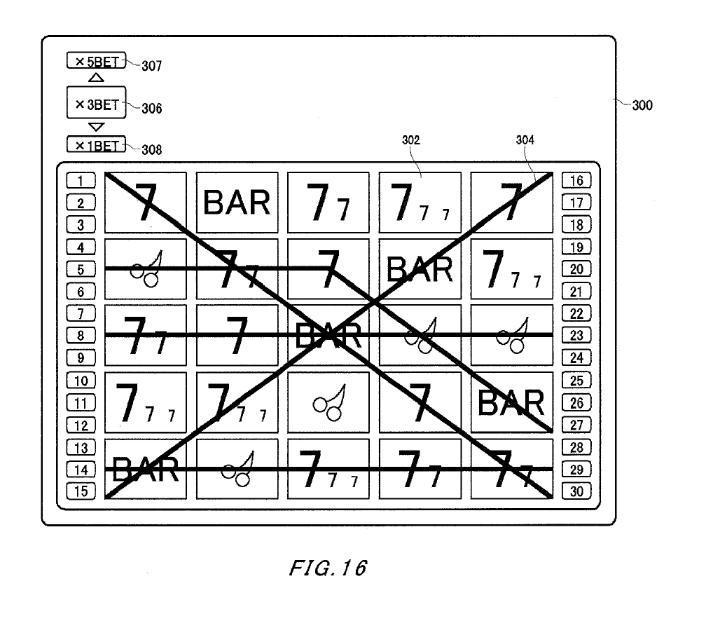

FIG. 16 illustrates one example of an image 300 displayed on the display part 14 provided in the main body 12 of the slot machine 10 according to one or more embodiments. The image 300 includes: reels 302 that indicate a plurality of patterns; winning lines 304 being set, a number of bets 306 being set; a number of bets 307 on an ascending order side that indicates the number of bets to be displayed next when the combination of number of lines and the number of bets is switched in an ascending order by the push-button switch 124; and a number of bets 308 on a descending order side that indicates the number of bets to be displayed next when the combination of the number of lines and the number of bets is switched in a descending order by the push-button switch 126.

Every time the combination of the number of lines and the number of bets to be presented as a selection target item is switched by the push-button switch 124 or the push-button switch 126, the lines of the winning lines 304 and the numbers of bets of the numbers of bets 306, 307, and 308 that are displayed in the image 300 are switched.

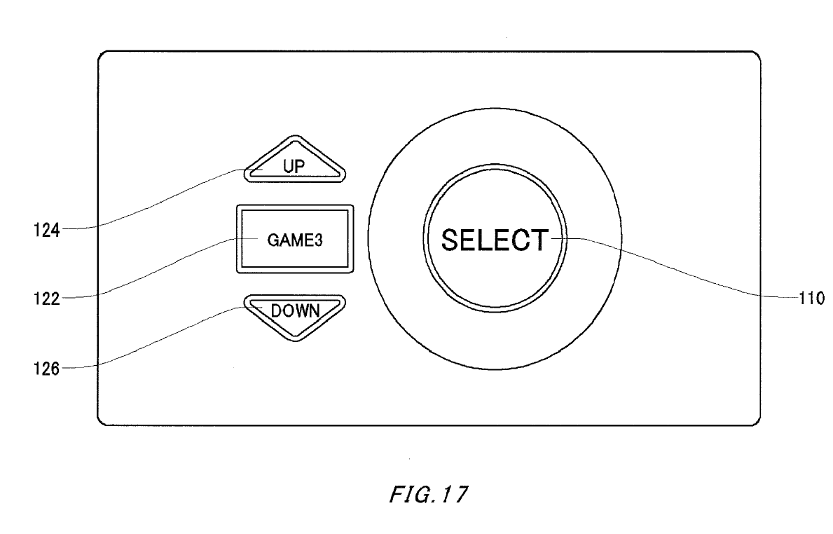

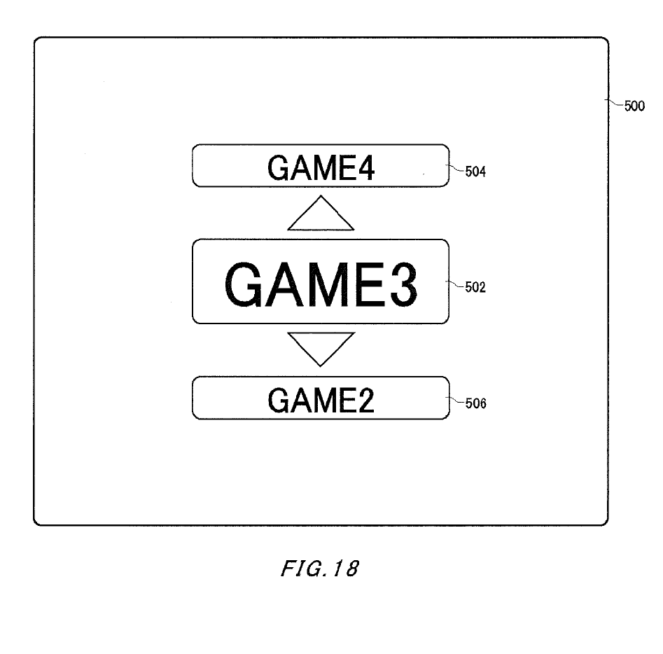

FIG. 17 illustrates another one example of objects that are made visible through the pressing surfaces of the push-button switch 110 according to one or more embodiments, the push-button switch 122, the push-button switch 124, and the push-button switch 126.

The display unit 160 may display, at a position that corresponds to the pressing surface of the push-button switch 122, an operation image that includes, as a selection target item object, an item that corresponds to any one mini game from among a plurality of items that correspond to a plurality of mini games that can be selected under predetermined conditions during a game. The plurality of items that correspond to the plurality of selectable mini games are respectively associated with a presentation order.

The operation image displayed by the display unit 160 further includes, at a position that corresponds to the pressing surface of the push-button switch 124, an ascending order object including text “UP” that indicates switching of selection target item objects in an ascending order. In addition, the operation image displayed on the display unit 160 further includes, at a position that corresponds to the pressing surface of the push-button switch 126, a descending order object including text “DOWN” that indicates switching of selection target item objects in a descending order.

The operation image displayed by the display unit 160 includes, at a position that corresponds to the pressing surface of the push-button switch 110, an object including text “SELECT” that indicates an instruction to select a mini game that corresponds to a selection target item object. When the push-button switch 110 is pressed, a mini game that corresponds to a selection target item object displayed at a position that corresponds to the pressing surface of the push-button switch 122 is started. Note that when the push-button switch 122 is pressed, a mini game that corresponds to a selection target item object displayed at a position that corresponds to the pressing surface of the push-button switch 122 may be started.

FIG. 18 illustrates another one example of an image 500 displayed on the display part 14 that is provided to the main body 12 of the slot machine 10 when a mini game is selected via the operation unit 100 according to one or more embodiments. An object 502 that indicates a type of a mini game displayed as a selection target item, an object 504 that indicates a type of a mini game to be displayed next as a selection target item when the push-button switch 124 is pressed, and an object 506 that indicates a type of a mini game to be displayed next as a selection target item when the push-button switch 126 is pressed may be displayed on the display part 14.

As described above, by displaying one image including objects that indicate respective functions of push-button switches on the single display unit 160, it becomes unnecessary to synchronize respective display units as in a case where display units are prepared for respective push-button switches. Also, the cost can be reduced as compared with a case where the operation unit 100 comprises a plurality of display units.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An operation unit comprising:
a first push-button switch;
a diffusion unit that diffuses light incident from a light-emitting part, and radiates light from a periphery of the first push-button switch; and
a rotary mechanism that rotates the diffusion unit.

2. The operation unit according to claim 1, wherein
the diffusion unit comprises a through-hole,
the rotary mechanism rotates the diffusion unit about a rotation axis that passes through the through-hole, and
the first push-button switch is disposed on the rotation axis.

3. The operation unit according to claim 1, further comprising, below the first push-button switch, a display unit that displays an image including a first object,
wherein the first push-button switch is disposed above a display area of the first object, and makes visible the first object through a pressing surface of the first push-button switch.

4. The operation unit according to claim 3, further comprising a second push-button switch,
wherein the display unit displays the image further including a second object, and
the second push-button switch is disposed above a display area of the second object, and makes visible the second object through a pressing surface of the second push-button switch.

5. The operation unit according to claim 4, further comprising a third push-button switch and a fourth push-button switch,
wherein the display unit displays the image further including a third object and a fourth object,
the third push-button switch is disposed above a display area of the third object, and makes visible the third object through a pressing surface of the third push-button switch, and
the fourth push-button switch is disposed above a display area of the fourth object, and makes visible the fourth object through a pressing surface of the fourth push-button switch.

6. The operation unit according to claim 5,
wherein the first push-button switch and the second push-button switch are disposed side by side in a first direction that is parallel with a screen of the display unit, and
the second push-button switch, the third push-button switch, and the fourth push-button switch are disposed side by side in a second direction that is parallel with the screen of the display unit and is vertical to the first direction.

7. The operation unit according to claim 6, wherein the second push-button switch is disposed between the third push-button switch and the fourth push-button switch.

8. The operation unit according to claim 5,
wherein the pressing surface of the first push-button switch is round,
the pressing surface of the second push-button switch is rectangular, and
the pressing surfaces of the third push-button switch and the fourth push-button switch are triangular.

9. The operation unit according to claim 5, further comprising an elastic sheet between the first push-button switch, the second push-button switch, the third push-button switch, and the fourth push-button switch, and the display unit,
wherein the first push-button switch, the second push-button switch, the third push-button switch, and the fourth push-button switch have leg parts that are supported on the elastic sheet.

10. The operation unit according to claim 9, wherein
the elastic sheet comprises a through-hole below the first push-button switch, and
the operation unit further comprises, inside the through-hole of the elastic sheet, an elastic body that supports the first push-button switch.

11. The operation unit according to claim 9, further comprising a base plate that is disposed between the elastic sheet and the display unit, and comprises, on a surface on the elastic sheet side, a plurality of fixed contacts facing the leg part of each of the first push-button switch, the second push-button switch, the third push-button switch, and the fourth push-button switch,
wherein the elastic sheet comprises, on a surface on the base plate side, a plurality of movable contacts facing the plurality of fixed contacts.

12. The operation unit according to claim 11, wherein the base plate comprises a plurality of through-holes that face the pressing surface of each of the first push-button switch, the second push-button switch, the third push-button switch, and the fourth push-button switch.

13. The operation unit according to claim 12, further comprising the light-emitting part that is disposed on the base plate, and allows light to be incident on the diffusion unit.

14. The operation unit according to claim 13, wherein
the light-emitting part comprises a plurality of light-emitting elements, and the plurality of light-emitting elements are disposed with intervals therebetween on the base plate, along the outer circumference of a through-hole that faces the pressing surface of the first push-button switch, from among the plurality of through-holes of the base plate.

15. The operation unit according to claim 14, further comprising a plurality of other light-emitting elements that radiate light from peripheries of the second push-button switch, the third push-button switch, and the fourth push-button switch,
wherein the plurality of other light-emitting elements are disposed with intervals therebetween on the base plate along the outer circumference of each through-hole that faces the pressing surfaces of the second push-button switch, the third push-button switch, and the fourth push-button switch, from among the plurality of through-holes of the base plate.

16. The operation unit according to claim 1,
wherein the diffusion unit comprises a disk body including, on an outer circumference thereof, a plurality of teeth, and
the rotary mechanism comprises:
a toothed wheel including, on an outer circumference thereof,
a plurality of teeth that gear the plurality of teeth of the disk body; and
a drive part that rotates the toothed wheel.

17. The operation unit according to claim 7, wherein
the pressing surface of the first push-button switch is round,
the pressing surface of the second push-button switch is rectangular, and the pressing surfaces of the third push-button switch and the fourth push-button switch are triangular.

18. The operation unit according to claim 17, further comprising an elastic sheet between the first push-button switch, the second push-button switch, the third push-button switch, and the fourth push-button switch, and the display unit,
wherein the first push-button switch, the second push-button switch, the third push-button switch, and the fourth push-button switch have leg parts that are supported on the elastic sheet,
the operation unit further comprises a base plate that is provided between the elastic sheet and the display unit, and comprises, on a surface on the elastic sheet side, a plurality of fixed contacts facing the leg part of each of the first push-button switch, the second push-button switch, the third push-button switch, and the fourth push-button switch,
the elastic sheet comprises a through-hole below the first push-button switch, and comprises, on a surface on the base plate side, a plurality of movable contacts facing the plurality of fixed contacts, and
the operation unit further comprises, inside the through-hole of the elastic sheet, an elastic body that supports the first push-button switch.

19. The operation unit according to claim 18, further comprising:
the light-emitting part that is disposed on the base plate, and allows light to be incident on the diffusion unit; and
a plurality of other light-emitting elements that radiate light from peripheries of the second push-button switch, the third push-button switch, and the fourth push-button switch, wherein
the base plate comprises a plurality of through-holes that face the pressing surface of each of the first push-button switch, the second push-button switch, the third push-button switch, and the fourth push-button switch,
the light-emitting part comprises a plurality of light-emitting elements,
the plurality of light-emitting elements are disposed with intervals therebetween on the base plate, along the outer circumference of a through-hole that faces the pressing surface of the first push-button switch, from among the plurality of through-holes of the base plate,
the plurality of other light-emitting elements are disposed with intervals therebetween on the base plate along the outer circumference of each through-hole that faces the pressing surfaces of the second push-button switch, the third push-button switch, and the fourth push-button switch, from among the plurality of through-holes of the base plate,
the diffusion unit comprises a disk body including, on an outer circumference thereof, a plurality of teeth, and
the rotary mechanism comprises:
a toothed wheel including, on an outer circumference thereof,
a plurality of teeth that gear the plurality of teeth of the disk body; and
a drive part that rotates the toothed wheel.
